(19) United States
(12) Patent Application Publication
(10) Pub. No.: US 2013/0114825 A1
(43) Pub. Date: May 9, 2013

(54) HEADSET WITH A LIGHT EMITTING NECKBAND

(71) Applicant: GN Netcom A/S, Ballerup (DK)

(72) Inventor: Flemming Bach Andreasen, Klarup (DK)

(73) Assignee: GN Netcom A/S, Ballerup (DK)

(21) Appl. No.: 13/666,506

(22) Filed: Nov. 1, 2012

(30) Foreign Application Priority Data
Nov. 4, 2011 (DK) PA 2011 00860

(51) Int. Cl. H04R 1/10

(52) U.S. Cl. 381/74

(57) ABSTRACT

A headset (1) comprising two earphones (2R, 2L) for arranging at the right and left ears of a user. The right and left earphones (2R, 2L) are interconnected by a neckband (4). The neckband (4) comprises light emitting means (5; 6; 8; 9; 10).

### TECHNICAL FIELD

The invention relates to a headset comprising two earphones for arranging at the right and left ears of a user and a neckband interconnecting the right and left earphones.

### BACKGROUND ART

Headsets with two earphones are preferred when listening to music, especially as the music can be in stereo. These stereo or duo headsets can be provided with different wearing styles. The most common types are: headband, neckband, ear hooks or in the ear-earphones. The headband is known from what is normally referred to as headphones and is designed to rest on the top of the head. A neckband is connecting the two earphones behind the head and is in more suitable for being worn together with headgear such as a hat, a cap or a bicycle helmet. Furthermore, neckbands are mostly provided with curved portions designed to rest behind the auricles and the risk of losing the headset during exercise is reduced compared to normal headphones provided with headbands. A headset with such a neckband is known from US 2008/037816 (Samsung).

The purpose of the invention is to provide an improved headset of the neckband type.

### DISCLOSURE OF INVENTION

The headset according to the invention is characterised in that the neckband comprises light emitting means. Thus, a runner, a pedestrian or cyclist can better be seen in dark conditions, whereby safety can be improved. A neckband with light emitting means can be seen from behind even if the user is wearing a bicycle helmet or f. ex. a knitted hat.

The neckband may comprise a longitudinal light conducting member, which is end lighted by a least one light source.

The longitudinal light conducting member can be a tube.

Alternatively, the longitudinal light conducting member is shaped as a light conducting core member, wherein electrical conductors run parallel with the light conducting core member in a light conducting cladding.

The entire neckband may be adapted to be light emitting.

The light source, such as a LED (light emitting diode), may be provided in an earphone. A light source may be provided in both earphones.

According to an embodiment, a centre part of the neckband comprises light emitting means. Thus, the part of the neckband being visible from most angles can emit light.

The light emitting means may comprise distinct light emitting objects arranged along the neckband. Thus, separate LED's may be provided along the neckband.

According to an embodiment, the light emitting means are powered by a battery contained by the headset. This battery may be rechargeable.

According to an embodiment, the headset comprises a light sensor and a motion sensor, wherein the light emitting means are only powered on, when the light sensor detects light below a predetermined limit and the motion sensor detects motion. Thus, power can be saved, as the user does not have to switch it off after use or when using the headset in full day light. The headset may be provided with means to switch off this functionality.

The light emitting means may be adapted to provide pulsating light. Pulsating or not, the light may be red as this is in conformity with rear lights of vehicles.

### BRIEF DESCRIPTION OF THE DRAWINGS

The invention is explained in detail below with reference to the drawing illustrating preferred embodiments of the invention and in which

FIG. 1 is a perspective view of a preferred embodiment of a headset according to the invention,

FIG. 2 is a sectional view through a neckband and an earphone of a headset according to the invention, and

FIG. 3 is a perspective view of a second embodiment of a headset according to the invention,

FIG. 4 is cross-sectional view through a neckband according to another neckband of the invention.

FIG. 5 is a perspective view of a another embodiment of a headset according to the invention.

### MODES FOR CARRYING OUT THE INVENTION

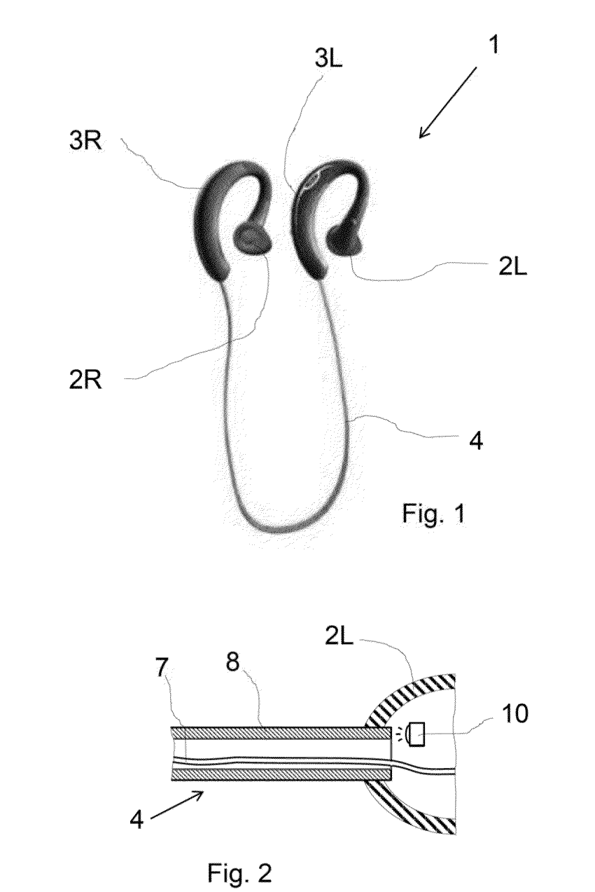

FIG. 1 discloses a headset 1 according to a first embodiment of the invention. The headset 1 comprises an earphone 2L for emitting audio to the left ear of a user and an earphone 2R for emitting audio to the right ear of a user. A part of each earphone 2L, 2R is shaped as an ear hook 3L, 3R, so that the earphone can be attached around the root of the auricle. The headset is a wireless Bluetooth headset, whereby it contains a Bluetooth transceiver and rechargeable battery in one of the earphones 2L, 2R. The two earphones 2L, 2R are interconnected by a flexible neckband 4 whereby audio can be conducted between the earphones. When the headset is worn, the neckband 4 hangs behind the neck of the user.

FIG. 2 discloses a sectional view through the neckband 4 and a part of the left earphone 2L. The neckband 4 comprises a flexible transparent light conducting tube 8, through which two electrical conductors 7 run. A LED (light emitting diode)10 is provided as a light source in the earphone 2L and is directing light into the end of the tube 8 when switched on. Thus, the tube material is illuminated and is visible from outside. When a user wearing the headset 1 is out running under dark conditions, he is visible from behind due to the lighting neckband. The light colour is preferably red as this is in correspondence with rear lights of vehicles. The light may also be pulsating, flashing or change colour in order to improve visibility.

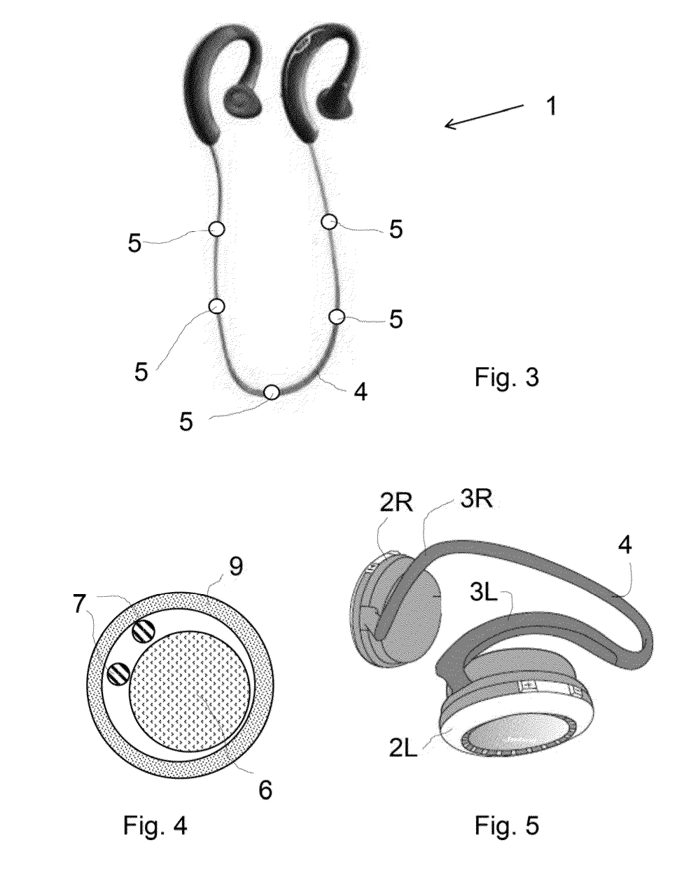

FIG. 3 discloses an alternative embodiment where the neckband 4 is provided with a number of LED's 5 in place of a continuously lighting band.

FIG. 4 discloses a neckband, which differs in cross-section from the neckband shown in FIG. 2. Here the neckband 4 comprises a light emitting core member 6 and two electrical conductors 7 inside a transparent cladding 9. It is not shown, but the light emitting core member 6 is end lighted by a light source, such as a LED, and light is directed via the outer surface of the core member 6 through the cladding 9 to the surroundings.

FIG. 5 discloses another embodiment of a headset 1, where the ear hooks 3L, 3R are integrated parts of the neckband 4, and wherein the neckband 4 is a more rigid member forcing the two earphones 2L, 2R together. Furthermore, the earphones 2L, 2R are “on the ear” type earphones which are larger than the “in the ear” type earphones shown in FIGS. 1 and 2.

The headsets shown here are wireless headsets. However, the invention also relates to corded headsets.

### REFERENCES SIGNS

1 headset

2L left earphone

2R right earphone

3L left ear hook

4 neckband

5 light emitting objects

6 light emitting core member

7 electrical conductors

8 light conducting tube

9 transparent cladding

10 light source

1. A headset comprising two earphones for arranging at the right and left ears of a user and a neckband interconnecting the right and left earphones, wherein the neckband comprises light emitting means.

2. A headset according to claim 1, wherein the neckband comprises a longitudinal light conducting member, which is end lighted by a least one light source.

3. A headset according to claim 2, wherein the longitudinal light conducting member is a tube.

4. A headset according to claim 2, wherein the longitudinal light conducting member is shaped as a light conducting core member and wherein electrical conductors run parallel with the light conducting core member in a light conducting cladding.

5. A headset according to claim 2, wherein the entire neckband is adapted to be light emitting.

6. A headset according to claim 2, wherein the light source is provided in an earphone.

7. A headset according to claim 1, wherein a centre part of the neckband comprises light emitting means.

8. A headset according to claim 1, wherein the light emitting means comprise distinct light emitting objects arranged along the neckband.

9. A headset according to claim 6, wherein the light emitting means are powered by a battery contained by the headset.

10. A headset according to claim 1, wherein the headset comprises a light sensor and a motion sensor, and wherein the light emitting means are only powered on, when the light sensor detects light below a predetermined limit and the motion sensor detects motion.
